(19) United States
(12) Patent Application Publication
(10) Pub. No.: US 2021/0386039 A1
(43) Pub. Date: Dec. 16, 2021

(54) FISH BREEDING DEVICES WITH MAGNETIZER AND METHODS FOR ACCELERATING NORMAL FISH REPRODUCTION AND GROWTH RATES

(71) Applicant: CHINESE RESEARCH ACADEMY OF ENVIRONMENTAL SCIENCES, Beijing (CN)

(72) Inventors: Lieyu Zhang, Beijing (CN); Jiaqian Li, Beijing (CN); Xiaoguang Li, Beijing (CN); Guowen Li, Beijing (CN); Wei Li, Beijing (CN); Caole Li, Beijing (CN); Chen Zhao, Beijing (CN); Lulu Che, Beijing (CN); Qiuheng Zhu, Beijing (CN)

(21) Appl. No.: 17/280,859

(22) PCT Filed: Sep. 15, 2020
(86) PCT No.: PCT/CN2020/115347

§ 371 Date: Mar. 26, 2021

(30) Foreign Application Priority Data
Sep. 29, 2019 (CN) 2019109312891

(51) Int. Cl. A01K 61/17; A01K 61/95; A01K 63/04

(52) U.S. Cl. CPC A01K 61/17; A01K 63/047; A01K 61/95

(57) ABSTRACT

The disclosure relates to the technical field of aquaculture, and more particularly to a fish breeding device provided with a magnetizer and a method for accelerating normal propagation and growth speeds of fishes. The fish breeding device includes a box body, a controllable partition plate, an extraction pump, and the magnetizer; the controllable partition plate is arranged in the box body and used for dividing the inner space of the box body into a feeding area and a non-feeding area; the extraction pump is arranged on the controllable partition plate and used for exchanging the water body in the feeding area with the water body in the non-feeding area; the magnetizer is arranged on the outer wall of the box body corresponding to the feeding area, and used for magnetizing the water body of the feeding area. In the disclosure, fish eggs are further hatched by the magnetized water. An adjustable magnetic field is utilized to act on fishes in development so that the fishes normally propagate and grow without causing the problems of retarded embryo development, stagnation, deformity, and the like. Meanwhile, pollutants generated in a feeding process can be purified, the utilization rate of feed put in a breeding process is increased, intermittent magnetization is adopted, and the consumption of electric energy is reduced.

### TECHNICAL FIELD

The disclosure relates to the technical field of aquaculture, and more particularly to a fish breeding device with a magnetizer and a method for accelerating normal propagation and growth speeds of fishes.

### BACKGROUND

The magnetization water treatment is a process of scale inhibiting treatment of water by using the treatment action of the magnetic field effect on water. When water passes through a gap between NS poles of two permanent magnets and cuts off the magnetic force lines of the magnetic field, water can be magnetized.

In the prior art, there has been a technical solution in which seawater is magnetized to improve water quality, increase the content of dissolved oxygen in the water body and promote the development and hatching of fish eggs. Jiang Jingtian et al. conducted an experiment on the effect of magnetized water on the embryonic development of Ctenopharyngodon idella, Hypophthalmichthys molitrix and Aristichthys nobilis with a magnetic field intensity of 1500 ohms in the Qianyang Fish Farm, Dong gang city in 2002. The results showed that there was no obvious difference between magnetized water and common water during the embryonic development period, namely, from fertilized eggs to a blastopore closure stage. After the somite formation stage, the embryo development speed in the magnetized water was gradually accelerated compared with that in the common water until the hatching stage advanced by one development stage. Thus, the fish eggs were hatched about two hours in advance, and the hatching in the magnetized water was regular. In contrast, the hatching in the common water was irregular, with the phenomenon in which the fish eggs were hatched before they developed to the hatching stage. The average hatching rate of the magnetized water was 90.67%, and that of the common water was 84.66%, such that the average hatching rate of the magnetized water was 6% higher than that of the common water.

However, there are no relevant studies and reports on the effects of magnetized water on fish embryo development.

Through long-term research, the inventors found that nitrogen and oxygen, the main components of air, are affected by different actions of magnetic fields, wherein nitrogen is a diamagnetic substance (repelled by the magnetic force and moving away from the magnetic field), while oxygen is a paramagnetic substance. After the water is treated by a magnetic field, the physical and chemical properties of water can be adjusted just by changing the structure of water and the morphologies of impurities existing in the water, which will produce a biological effect on animals. The structure of water is composed of a model of “flickering clusters,” i.e., composed of “flickering clusters” swimming in “free” water. There is less “free” water in common water. After water is magnetized, some “clusters” can become more “free” water, which has a strong biological activity.

Furthermore, the water contains many ions. After the water is treated by the magnetic field, it will significantly affect the hydration of the ions, which will increase the negative hydration actions and decrease the positive hydration actions of the corresponding ions, and in turn increase the number of more active individual free water molecules, resulting in the increase of the activity, viscosity, density and osmotic pressure of the water. Also, the diameter of the fish eggs is smaller than that in the common water due to the increase of the osmotic pressure of the magnetized water.

However, the magnetization intensity being too high can also lead to changes in the active genes of fishes, resulting in changes in the metabolic mechanisms; the effect on the charged ions in fish embryos being too large will affect the enzyme activity during the development of fish embryos, change the permeability of cell membranes, and make fish embryos develop slowly, stagnate or become deformed. In terms of the relationship between the magnetic field and animal growth and animal embryo development, experimental studies have been carried out on a variety of animals. For example, the early division of sea urchin eggs was significantly delayed after 2 hours in a strong superconducting magnetic field of 10000-140000 ohms, and the distortion rate of drosophila was increased in the next generation after being treated with a magnetic field of 3,000-4,000 ohms.

### SUMMARY

In order to solve the technical problems presented in the prior art, an objective of the disclosure is to provide a breeding device with a magnetizer and a method for accelerating normal propagation and growth speeds of fishes.

In order to realize the objective of the disclosure, the technical solution of the disclosure is as follows.

In the first aspect, the disclosure provides a fish breeding device with a magnetizer, including: a box body, a controllable partition plate, an extraction pump, and the magnetizer.

The controllable partition plate is arranged in the box body and configured to divide the inner space of the box body into a feeding area and a non-feeding area.

The extraction pump is arranged on the controllable partition plate and used to exchange the water body in the feeding area with the water body in the non-feeding area.

The magnetizer is arranged on the outer wall of the box body corresponding to the feeding area, and configured to magnetize the water body of the feeding area.

There may be two extraction pumps for oppositely exchanging water bodies in the feeding area and the non-feeding area.

The magnetizer is preferably an electromagnetic magnetizer that can magnetize the feeding area, especially the precipitation area after the bait is precipitated.

The height of the precipitation area is generally ⅕-¼ of that of the feeding area.

Therefore, the magnetizer is preferably arranged on the outer wall of the box body in the precipitation area (⅕-¼ of the lower part of the feeding area).

Further, the fish breeding device also includes a water inlet system, a water outlet system, and an on-line water quality monitoring device installed in the box body. The on-line water quality monitoring device is arranged in the non-feeding area.

In a second aspect, the disclosure provides a method for accelerating the normal propagation and growth speeds of fishes by using the fish breeding device, the method including:

(1) hatching of fertilized eggs:

the fertilized eggs of fishes are hatched with magnetized water; after the fish eggs are fertilized, the fertilized eggs are placed in magnetized water for hatching;

further, when artificial insemination (such as a dry method of artificial insemination) is adopted, magnetized water can also be used to make the egg membrane absorb water and expand, and the expanded fertilized eggs can be placed in the magnetized water for hatching;

the magnetized water is water treated by a magnetic field with an intensity of 700-1000 mT;

(2) fry breeding:

At the non-feeding phase: the controllable partition plate is in an opened state, and the fishes may move freely in the box body;

At the feeding time, it operates as follows:

S1. feeding bait into a feeding area on one side of a controllable partition plate, closing the controllable partition plate after the fishes enter the feeding area, sealing the feeding area, and meanwhile turning on a magnetizer to magnetize the feeding area with a magnetization intensity of 500-1500 mT;

S2. after the bait is precipitated, extracting the water body at the upper part of the feeding area to the non-feeding area by using an extraction pump, and reserving part of the water volume available for fish movement;

S3. extracting part of the water body in the non-feeding area to the feeding area by using the extraction pump to resuspend the precipitated bait in the feeding area, and adjusting the magnetization intensity of the magnetizer to be 50-500 mT;

S4. discharging the water body containing the precipitated bait out of the box body after the bait is precipitated again;

S5. turning off the magnetizer and opening the controllable partition plate, so that the fishes can move freely in the box body.

In the breeding season of fishes, a larger magnetic field intensity can be adopted within the above magnetic field intensity range. The researches show that the magnetized water can increase the dissolved oxygen concentration to 5-6 mg/L, improve the osmotic pressure by 1.34 times, and improve the transparency by over 20% and increase the pH by 0.4-1.0. In the disclosure, weakly magnetized water is used for raising fishes, so that the water quality of the box body can be improved and the water changing time of the box body can be prolonged. Meanwhile, due to the physiological action of the magnetized water, the normal growth and propagation speeds of fishes can be accelerated.

Preferably, the frequency of bait feeding is 2 times/day, that is, feeding twice a day, and the single bait feeding rate is 4%.

The bait feeding rate refers to the percentage of the bait feeding amount in the total body weight of the bred aquatic animals.

Preferably, the magnetic field provided by the magnetizer is a pulsed magnetic field.

The pulsed magnetic field is a magnetic field whose magnitude and direction both change over time and whose frequency, waveform, and peak value can be adjusted as needed. The pulsed magnetic field has different effects on the enzyme activity under different intensities, times, and frequencies. The research shows that, under the action of a weak magnetic field (1500 mT), the activity of the catalase can be increased by about 25%, the activity of the a-amylase is increased by about 35%, and the activity of the urease is increased by about 15%. The magnetic field will affect the activity of the enzyme by acting on the transition metal atoms (ions) of which the electronic shells are not filled full, such as Co, Fe, Mn, Cu, and Mo. At the same time, the existing research results show that the treatment with the magnetic field can change the physical and chemical properties of the aqueous solution, such as viscosity, surface tension, conductivity, etc., so it can also affect the conformation of the enzyme by affecting the structures of water molecules and changing the lengths and strengths of hydrogen bonds in the water. The increase in these enzyme activities can improve the metabolic capacity of fishes and promote their growth and propagation.

In the breeding season, the increase in the water activity can change the enzyme activity when acted on the animals. It enhances the activity of a hatching enzyme in fish embryo development, thereby promoting metabolism, material transformation, and the like physiological functions, and accelerating the embryo development speed. This effect has little influence when the fertilized eggs develop to the blastopore closure stage since this stage is only a simple process of cell increase, and the action is not obvious. With the increase of the number of egg cells, qualitative changes have taken place in embryo development. When the egg cells enter the stage of organogenesis and tissue differentiation, the hatching enzyme plays a more and more important role, and thus this effect is exhibited obviously. Oxygen is concentrated in places at which the magnetic force is strong, thereby increasing the dissolved oxygen in the pool water and promoting the development of fish embryos.

Furthermore, the magnetized water has a good treatment effect on COD and BOD due to the strong oxidizing free radical oxidation generated by it, which can remove suspended matters, improve the water quality of the box body, and reduce the influence of the bait on the water quality.

Further, an on-line water quality monitoring device is arranged in the fish breeding device, and when the dissolved oxygen concentration in the water body is monitored to be lower than 3 mg/L and/or the pH is higher than 9.0, the fish breeding water needs to be replaced.

The fish breeding water is preferably water with pH=8, a molecular ammonia concentration ≤0.02 mg/L, a dissolved oxygen concentration of 4 mg/L and a temperature of 18° C.

Further, the ratio of the feeding area to the non-feeding area is optionally 1:5-1:3.

The raw materials involved in the disclosure are all common commercially-available products, and the operations involved in the disclosure are all normal operations in the art, unless otherwise specified.

Based on conforming to the common knowledge in the art, the aforementioned preferred conditions can be combined with each other to obtain specific embodiments.

The beneficial effects of the disclosure are as follows.

The disclosure provides a device and method for accelerating normal propagation and growth speeds of fishes. That is, the fish eggs are treated and hatched by the magnetized water, and an adjustable magnetic field is utilized to act on fishes in development, so that the fishes normally propagate and grow without causing the problems of retarded embryo development, stagnation, deformity, and the like; meanwhile, pollutants generated in a feeding process can be purified, and the utilization rate of feed put in a breeding process is increased.

In the disclosure, intermittent magnetization is adopted, the consumption of electric energy is reduced, and the application of the extraction pump improves the utilization rate of feed put in a breeding process. The method can promote the normal growth and development of fishes, and meanwhile control the pollution of the box body.

### BRIEF DESCRIPTION OF THE DRAWINGS

FIG. 1 is a schematic structural diagram of the fish breeding device provided with a magnetizer in accordance with the disclosure.

In Figure: 1: a box body, 2: a controllable partition plate, 3: an extraction pump, 4: a magnetizer, 5: a feeding area, 6: a non-feeding area, 7: a water inlet system, 8: a water outlet system, 9: an on-line water quality monitoring device, and 10: a precipitation area.

### DETAILED DESCRIPTION OF THE EMBODIMENTS

The preferred implementation modes of the disclosure will be further described in detail hereafter with reference to embodiments. It should be understood that the following embodiments are given for illustrative purposes only, and are not intended to limit the scope of the disclosure. Those skilled in the art can make various modifications and substitutions to the disclosure, without departing from the tenets and spirit of the disclosure.

The experimental methods used in the following embodiments are conventional methods, unless otherwise specified.

The materials, reagents, etc. used in the following embodiments are commercially available, unless otherwise specified.

### Embodiment 1

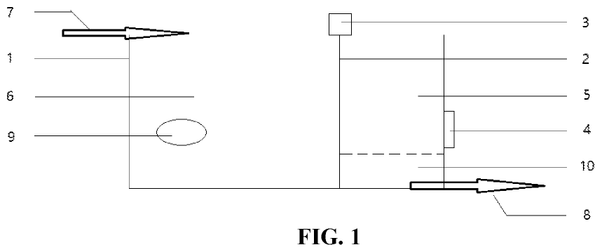

This embodiment is used for illustrating a fish breeding device provided with a magnetizer. As shown in FIG. 1, the fish breeding device included a box body 1, a controllable partition plate 2, an extraction pump 3, a magnetizer 4, a water inlet system 7, a water outlet system 8, and an on-line water quality monitoring device 9.

The controllable partition plate 2 is arranged in the box body 1 and used for dividing the inner space of the box body 1 into a feeding area 5 and a non-feeding area 6.

The precipitation area 10 is an area where the bait is precipitated after bait feeding, and its height was generally ⅕-¼ of that of the feeding area 5. The magnetizer 4 is an electromagnetic magnetizer, which is arranged on the outer wall of the box body in the precipitation area 10 (⅕-¼ of the lower part of the feeding area), and is used for magnetizing the water body in the feeding area 5, especially the water body in the precipitation area 10 by adopting a pulsed magnetic field.

Two extraction pumps 3 are arranged on the controllable partition plate 2 for oppositely exchanging water bodies in the feeding area 5 and the non-feeding area 6.

### Embodiment 2

Using the fish breeding device provided with the magnetizer as described in Embodiment 1, the breeding of Ctenopharyngodon idella by the method of the disclosure was simulated in the laboratory.

Experimental Materials:

Two box bodies with a length of 200 cm, a width of 100 cm and a height of 100 cm (an experimental group and a control group respectively) were taken, and the left and right sides of the box bodies were provided with a water inlet pipe and a water outlet pipe with a diameter of 100 mm respectively.

An electromagnetic magnetizer with a magnetic field intensity of 500-1000 mT was arranged outside the precipitation area in the experimental group, while no magnetic field was arranged in the control group, and the other conditions were the same.

20 Ctenopharyngodon idella (about 250 g/fish) were bred in each of the box bodies. The pH value of the water used for fish breeding may be 8.0, the molecular ammonia concentration may be ≤0.02 mg/l. The dissolved oxygen concentration may be 4 mg/L The temperature may be 18° C. The bait feeding frequency may be 2 times/day. The bait feeding rate may be 4%. An on-line water quality monitoring device may be installed in the box body. When the water quality is that the dissolved oxygen concentration is lower than 3 mg/L and the pH is higher than 9.0, the fish breeding water needs to be replaced.

In the experimental group, a magnetization reactor was turned on at the eating of the fishes until the feeding was completed, and then the controllable partition plate was closed, the magnetizing time was about 60 min, the intermittent magnetizing period was 12 h, and the magnetization operated continuously for 2 months.

The experimental results showed that: the body weights of Ctenopharyngodon idella in the experimental group were increased by 5% compared with those of the control group, with an average up to 300 g/fish, and the number of water changes in the experimental group was reduced by 3 compared with the control group, the water being changed every 9-10 days.

### Embodiment 3

The fish eggs of healthy Ctenopharyngodon idella were subjected to a dry method of artificial insemination, and the fertilized eggs of the same fish were divided equally into two parts. One part was inflated by absorbing the magnetized water (with a magnetic field intensity of 700-1000 mT, and a flow rate of 20 ml/min) into the egg membrane, and the other part was inflated by absorbing the common fish breeding water (slightly alkaline (pH 8.0), with a hardness of 6, transparency of about 30 cm, and the dissolved oxygen concentration of 4 mg/L) into the egg membrane. The two kinds of fertilized eggs were respectively put into containers containing the magnetized water or the common fish breeding water, and hatched in a culture dish with a diameter of 9 cm in the laboratory. One group was fertilized eggs treated with the common water, and the other group was fertilized eggs treated with the magnetized water.

Each large group was divided into 2 small groups, 60 fertilized eggs were put in each small group and 30 fertilized eggs were put in each culture dish, which were respectively put into 40 ml of magnetized water or tap water for hatching. The whole embryonic development period from the beginning of the fertilized egg to the stage of swimbladder chamber formation was observed, three stages, i.e., a midgastrula stage, a hatching stage and a swimbladder chamber formation stage, were selected to count the fertilization rate (referring in particular to the fertilization rate when the fertilized eggs develop to the midgastrula stage), hatching rate and deformity rate respectively, and the values of three batches of experiments were averaged.

Statistics of experimental results

| | | | | | Number of | Number of | |
|---|---|---|---|---|---|---|---|
| | | | Number of | | normal | deformed | |
| | | | hatched-out | | hatched-out | hatched-out | |
| Batch | | Fertilization | fishes | Hatching | fishes | fishes | Deformity |
| Number | Groups | rate (%) | (fishes) | rate (%) | (fishes) | (fishes) | rate (%) |
| I | The | 91.4 | 22 | 40.1 | 20 | 2 | 9.1 |
| | fertilized | | | | | | |
| | eggs | | | | | | |
| | treated | | | | | | |
| | with the | | | | | | |
| | magnetized | | | | | | |
| | water and | | | | | | |
| | hatched | | | | | | |
| | with the | | | | | | |
| | magnetized | | | | | | |
| | water | | | | | | |
| | The | 86.4 | 18 | 34.7 | 14 | 4 | 22.2 |
| | fertilized | | | | | | |
| | eggs | | | | | | |
| | treated | | | | | | |
| | with the | | | | | | |
| | magnetized | | | | | | |
| | water and | | | | | | |
| | hatched | | | | | | |
| | with the | | | | | | |
| | common | | | | | | |
| | water | | | | | | |
| | The | 87.8 | 19 | 36.1 | 13 | 6 | 31.6 |
| | fertilized | | | | | | |
| | eggs | | | | | | |
| | treated | | | | | | |
| | with the | | | | | | |
| | common | | | | | | |
| | water and | | | | | | |
| | hatched | | | | | | |
| | with the | | | | | | |
| | magnetized | | | | | | |
| | water | | | | | | |
| | The | 80.2 | 15 | 31.2 | 10 | 5 | 33.3 |
| | fertilized | | | | | | |
| | eggs | | | | | | |
| | treated | | | | | | |
| | with the | | | | | | |
| | common | | | | | | |
| | water and | | | | | | |
| | hatched | | | | | | |
| | with the | | | | | | |
| | common | | | | | | |
| | water | | | | | | |

It is noted that hatching fish eggs with the magnetized water is more conducive to normal cell division and development of fertilized eggs to the midgastrula stage than the common water, with higher hatching rate and lower deformity rate after hatching-out.

### Embodiment 4

Using the fish breeding device provided with the magnetizer, the breeding of Ctenopharyngodon idella by the method of the disclosure was simulated in the laboratory, wherein one set of devices used a pulsed magnetic field, and the other set of devices used a steady magnetic field.

Experimental Materials:

Three box bodies with a length of 200 cm, a width of 100 cm and a height of 100 cm (experimental groups and a control group respectively) were taken, and the left and right sides of the box bodies were provided with a water inlet pipe and a water outlet pipe with a diameter of 100 mm respectively.

A pulse magnetic field with a magnetic field intensity of 500-1000 mT and a steady magnetic field with a magnetic field intensity of 700 mT may be arranged outside the precipitation areas of the experimental groups respectively, while no magnetic field is arranged in the control group, and the other conditions may be the same.

20 Ctenopharyngodon idella (about 250 g/fish) may be bred in each of the box bodies. The pH value of the water used for fish breeding may be 8.0. The molecular ammonia concentration may be ≤0.02 mg/l. The dissolved oxygen concentration may be 4 mg/L. The temperature may be 18° C. The bait feeding frequency may be 2 times/day, and the bait feeding rate may be 4%. An on-line water quality monitoring device may be installed in the box body. When the water quality is that the dissolved oxygen concentration is lower than 3 mg/L and the pH is higher than 9.0, the fish breeding water may be replaced.

In the experimental groups (the pulse magnetic field was used for I, and the steady magnetic field was used for II), a magnetization reactor may be turned on at the eating of the fishes until the feeding is completed. The controllable partition plate may then be closed. The magnetizing time may be about 60 min. the intermittent magnetizing period may be 12 h. The magnetization may operate continuously for 5 months.

The experimental results were: the body weights of Ctenopharyngodon idella in the experimental group I (pulsed magnetic field) were increased by 7% compared with those of the control group, with an average up to 380 g/fish, while the body weights in the experimental group II (steady magnetic field) were increased by 4% compared with those of the control group, with an average up to 370 g/fish, and the number of water changing in the experimental groups was reduced by 8 compared with the control group.

Although the disclosure has been described in detail with general description and specific embodiments hereinabove, it is obvious to those skilled in the art that some modifications or improvements can be made on the basis of the disclosure. Therefore, all such modifications or improvements made without departing from the spirit of the disclosure are within the claimed scope of the disclosure.

1. A fish breeding device with a magnetizer, comprising:
a box body, a controllable partition plate, an extraction pump, and the magnetizer; wherein the controllable partition plate is arranged in the box body and used for dividing the inner space of the box body into a feeding area and a non-feeding area;
the extraction pump is arranged on the controllable partition plate for exchanging the water body in the feeding area with the water body in the non-feeding area; and
the magnetizer is arranged on the outer wall of the box body corresponding to the feeding area for magnetizing the water body of the feeding area.

2. The fish breeding device according to claim 1, wherein there are two extraction pumps for oppositely exchanging water bodies in the feeding area and the non-feeding area.

3. The fish breeding device according to claim 1, wherein the magnetizer is an electromagnetic magnetizer.

4. The fish breeding device according to claim 1, wherein the fish breeding device further comprises a water inlet system, a water outlet system, and an on-line water quality monitoring device installed in the box body.

5. A method for accelerating the normal propagation and growth speeds of fishes, comprising:
hatching of fertilized eggs:
the fertilized eggs of fishes are hatched with magnetized water;
the magnetized water is water treated by a magnetic field with an intensity of 700-1000 mT; and
fry breeding, comprising:
at the non-feeding time: the controllable partition plate is in an opened state, and the fishes move freely in the box body;
performing a plurality of operations at the feeding time, wherein the plurality of operations comprises:
feeding bait into a feeding area on one side of a controllable partition plate, closing the controllable partition plate after the fishes enter the feeding area, sealing the feeding area, and meanwhile turning on a magnetizer to magnetize the feeding area with a magnetization intensity of 500-1500 mT;
after the bait is precipitated, extracting the water body at the upper part of the feeding area to the non-feeding area by using an extraction pump, and reserving part of the water volume available for fish movement;
extracting part of the water body in the non-feeding area to the feeding area by using the extraction pump to resuspend the precipitated bait in the feeding area, and adjusting the magnetization intensity of the magnetizer to be 50-500 mT;
discharging the water body containing the precipitated bait out of the box body after the bait is precipitated again; and
turning off the magnetizer and opening the controllable partition plate, so that the fishes move freely in the box body.

6. The method according to claim 5, wherein the frequency of bait feeding is 2 times/day, that is, feeding twice a day.

7. The method according to claim 6, wherein the single bait feeding rate is 4%.

8. The method according to claim 5, wherein the magnetic field provided by the magnetizer is a pulsed magnetic field.

9. The method according to claim 5, wherein an on-line water quality monitoring device is arranged in the fish breeding device, and when the dissolved oxygen concentration in the water body is monitored to be lower than 3 mg/L and/or the pH is higher than 9.0, the fish breeding water needs to be replaced.

10. The method according to claim 9, wherein the fish breeding water is water with pH=8, a molecular ammonia concentration ≤0.02 mg/L, a dissolved oxygen concentration of 4 mg/L and a temperature of 18° C.
